(19) United States
(12) Patent Application Publication
(10) Pub. No.: US 2025/0192204 A1
(43) Pub. Date: Jun. 12, 2025

(54) FUEL CELL SYSTEM DUST DETECTION AND EXHAUST

(71) Applicant: Caterpillar Inc., Peoria, IL (US)

(72) Inventor: Andrew D. WUETHRICH, Peoria, IL (US)

(73) Assignee: Caterpillar Inc., Peoria, IL (US)

(21) Appl. No.: 18/537,295

(22) Filed: Dec. 12, 2023

(51) Int. Cl. H01M 8/0438; H01M 8/04119; H01M 8/04746

(52) U.S. Cl. CPC H01M 8/04425; H01M 8/04126; H01M 8/04432; H01M 8/04753; H01M 8/04776; H01M 2250/20

(57) ABSTRACT

A dust purge system may include an inlet pressure sensor configured to measure an inlet pressure of a humidifier, an outlet pressure sensor configured to measure an outlet pressure of the humidifier, a purge valve movable between an open position to direct air output by the humidifier to a fuel cell and an exhaust position to vent air output by the humidifier away from the fuel cell, and an actuator configured to move the purge valve to the exhaust position in accordance with a difference between the outlet pressure and the inlet pressure.

### TECHNICAL FIELD

The present disclosure relates generally to a fuel cell system and, for example, to detecting and removing dust from the fuel cell system.

### BACKGROUND

Fuel cells can be used to power heavy machinery through a chemical process that typically involves a hydrogen reaction that creates electricity. Fuel cells emit water vapor and heat as byproducts, making them more environmentally friendly than other sources of energy. Additionally, fuel cells have a higher energy efficiency compared to internal combustion engines, which means fuel cells can potentially offer longer operational times for the same amount of fuel. Replacing or supplementing traditional engines with fuel cells in heavy machinery can therefore lead to reduced operating costs, lower emissions, and a reduced carbon footprint.

The operation of fuel cells in dusty environments, such as construction sites or mines, presents a challenge. Dust can clog air intake systems, inhibiting the supply of the oxygen that supports the fuel cell's chemical reaction. Moreover, dust particles can infiltrate the fuel cell itself, potentially causing damage and reducing the fuel cell's efficiency and lifespan.

China Patent No. 217589013 (the '013 patent) discloses a fuel cell air supply system for dust removal. The fuel cell air supply system includes a vehicle-mounted dust removal device comprising a fan, and the fan drives air to flow into a purification device to purify the air. The air transmission pipeline is led out from the air outlet of the purification device of the vehicle-mounted dust removal equipment in a branched manner. The air compressor is connected to the air transmission pipeline to transmit the purified air to an air inlet of a rear fuel cell stack so as to provide air for the fuel cell stack that can be used in a reaction.

The system described in the '013 patent, however, is unable to remove dust that is downstream of the air purification device. Therefore, any dust that flows through the air purification device or enters the system downstream of the air purification device can disrupt the operation of the fuel cell.

The dust purge system of the present disclosure solves one or more of the problems set forth above and/or other problems in the art.

### SUMMARY

A dust purge system may include an inlet pressure sensor configured to measure an inlet pressure of a humidifier, an outlet pressure sensor configured to measure an outlet pressure of the humidifier, a purge valve movable between an open position to direct air output by the humidifier to a fuel cell and an exhaust position to vent air output by the humidifier away from the fuel cell, and an actuator configured to move the purge valve to the exhaust position in accordance with a difference between the outlet pressure and the inlet pressure.

A fuel cell air supply system may include an air compressor, a humidifier in fluid communication with the air compressor, and a dust purge system in fluid communication with the humidifier. The dust purge system may be configured to selectively purge dust from the fuel cell air supply system. The dust purge system may include an actuator, and a purge valve, including an exhaust port, operatively connected to the actuator. The purge valve may be configured to move from an open position to direct air output by the humidifier to a fuel cell and an exhaust position to vent air output by the humidifier away from a fuel cell.

A method of purging air from an air supply system of a fuel cell system may include measuring an inlet pressure of a humidifier in fluid communication with a fuel cell of the fuel cell system, measuring an outlet pressure of the humidifier, comparing the inlet pressure to the outlet pressure to detect a pressure difference, and activating an actuator to direct air from the humidifier through an exhaust port and away from the fuel cell in accordance with the pressure difference.

### BRIEF DESCRIPTION OF THE DRAWINGS

FIG. 1 is a diagram of an example machine that includes a dust purge system.

FIG. 2 is a diagram of an example fuel cell system that may be used in the power source of the machine of FIG. 1.

FIGS. 3 and 4 are diagrams of an example dust purge system that may be used with a fuel cell air supply system.

FIG. 5 is a flowchart of an example process associated with detecting and removing dust from a fuel cell system.

### DETAILED DESCRIPTION

This disclosure relates to a dust purge system, which is applicable to any machine that uses a fuel cell as a power source. For example, the machine may perform an operation associated with an industry, such as mining, construction, farming, transportation, or any other industry. For example, the machine may be an electric vehicle, an electric work machine (e.g., a compactor machine, a paving machine, a cold planer, a grading machine, a backhoe loader, a wheel loader, a harvester, an excavator, a motor grader, a skid steer loader, a tractor, and/or a dozer), or an energy storage system, among other examples.

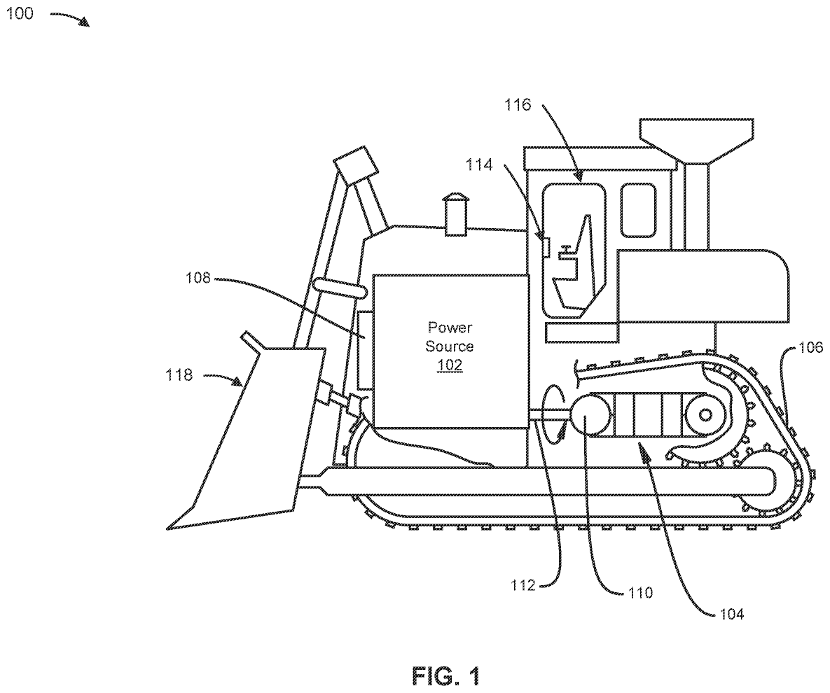

FIG. 1 is a diagram of an example machine 100 that includes a dust purge system. The machine 100 is shown as a track type tractor but may include any type of machine that includes a dust purge system capable of detecting and removing dust from a fuel cell system of the machine 100. As shown, the machine 100 may have a power source 102, an electric drive system 104, a traction system 106, an inverter 108, a generator 110, and a drive shaft 112.

The power source 102 may be configured to supply power to the machine 100. In some implementations, the power source 102 may be a direct current (DC) power source such as a fuel cell, as discussed in greater detail below. The power source 102 may be operably arranged to receive control signals from operator controls 114 in an operator station 116. The power source 102 may be operably arranged with the electric drive system 104 and/or an implement 118 to selectively operate the electric drive system 104 and/or the implement 118 according to control signals received from the operator controls 114. The power source 102 may provide operating power for the propulsion of the electric drive system 104 and/or the operation of the implement 118 via, for example, the electric drive system 104, the inverter 108, the generator 110, and/or the drive shaft 112, among other examples.

The electric drive system 104 may be operably arranged with the power source 102 to selectively propel the machine 100 via control signals from the operator controls 114. The electric drive system 104 may be operably connected to a plurality of ground-engaging members, such as traction system 106, as shown, which may be movably connected to the machine 100 through axles, drive shafts, and/or other components and which may be movably connected to the electric drive system 104 via the generator 110 and the drive shaft 112. In some implementations, the traction system 106 may be provided in the form of a track-drive system, a wheel-drive system, or any other type of drive system configured to propel the machine 100. In some implementations, the electric drive system 104 may be operably arranged with the power source 102 to selectively operate the implement 118, which may be movably connected to the machine 100 and to the electric drive system 104.

The inverter 108 may be electrically connected to the power source 102 and/or the electric drive system 104. In some implementations, the inverter 108 may receive a DC current from the power source 102 and may control a phase of the DC current to provide an alternating current (AC) to the generator 110. In this way, the inverter 108 may provide operating power for the propulsion of the machine 100 and/or the operation of the implement 118.

The implement 118 may be operably arranged with the electric drive system 104 such that the implement 118 is selectively movable through control signals transmitted from the operator controls 114 to the electric drive system 104, the inverter 108, the generator 110, and/or the drive shaft 112, among other examples. The illustrated implement 118 is a tractor loader. Other embodiments can include any other suitable implement for a variety of tasks, such as, for example, dozing, blading, brushing, compacting, grading, lifting, ripping, plowing, or the like. Example implements include dozers, augers, buckets, breakers/hammers, brushes, compactors, cutters, forked lifting devices, grader bits and end bits, grapples, or the like.

As indicated above, FIG. 1 is provided as an example. Other examples are possible and may differ from what was described in connection with FIG. 1.

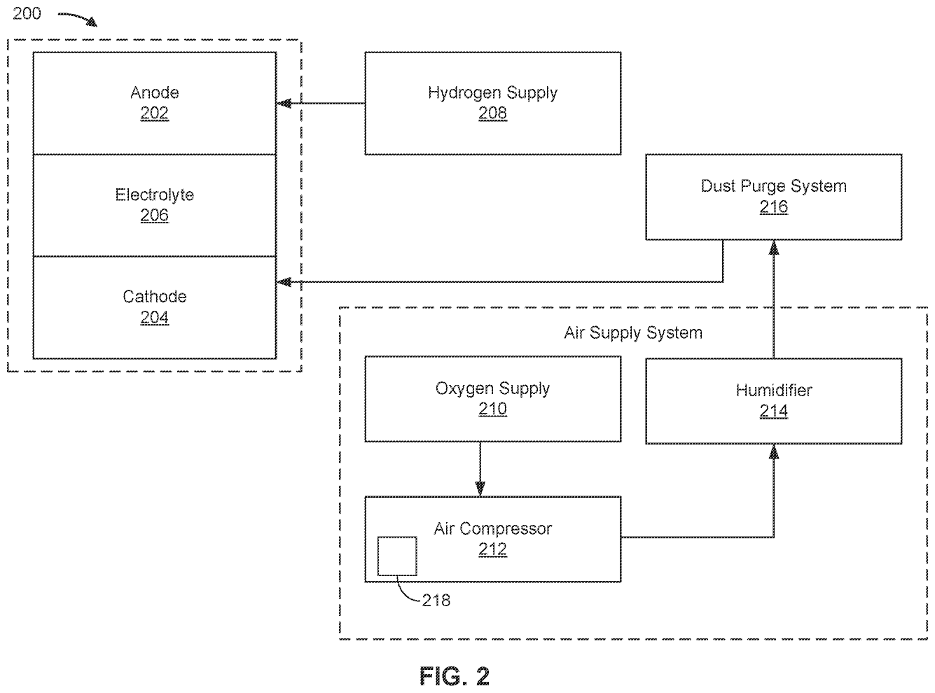

FIG. 2 is a diagram of an example fuel cell system that may be used in the power source 102 of the machine 100 of FIG. 1. The fuel cell system may include a fuel cell 200 including an anode 202, a cathode 204, and an electrolyte 206. The fuel cell system may further include a hydrogen supply 208, an oxygen supply 210, an air compressor 212, a humidifier 214, and a dust purge system 216. The oxygen supply 210, the air compressor 212, and the humidifier 214 may be collectively referred to as an “air supply system.”

The anode 202 may be one of the primary electrodes in the fuel cell 200. The anode 202 may facilitate the oxidation of the fuel in the fuel cell 200. For example, in a hydrogen fuel cell, hydrogen gas (H₂) may be introduced to the anode 202. A catalyst may be used to split the hydrogen molecules into protons (H⁺) and electrons (e⁻) through an oxidation process. The electrons produced may travel through an external load (e.g., the inverter 108) toward the cathode 204. This movement of the electrons from the anode 202 to the cathode 204 may create an electric current.

The cathode 204 may be the part of the fuel cell 200 where the reduction reaction occurs. For example, in a hydrogen fuel cell, once the electrons have traveled through the external load (such as the inverter 108) from the anode 202, the electrons may arrive at the cathode 204 where the oxygen may be present. At the cathode 204, the electrons may combine with the oxygen and with protons (which have traveled through the electrolyte 206 from the anode 202) to form water. This reduction process may result in a continuous flow of electrons from the anode 202 to the cathode 204, which may generate a continuous electric current that may be used to, for example, power the generator 110.

The electrolyte 206 may be used to conduct charged ions from one electrode to another, completing the electrochemical circuit within the cell. As discussed above, in a hydrogen fuel cell, after the hydrogen gas is split at the anode 202 into protons and electrons, the protons (H⁺) may travel through the electrolyte 206 to the cathode 204 where they combine with oxygen and electrons to form water. The electrolyte 206 may act as a barrier to the electrons, forcing the electrons to travel through the external load (e.g., the inverter 108), thereby producing electric power. The electrolyte 206 may further serve as a physical barrier that may separate the fuel (e.g., hydrogen) from the oxidant (e.g., oxygen) to prevent the fuels from mixing and combusting prematurely. The electrolyte 206 may be disposed between the anode 202 and the cathode 204 within the fuel cell 200. Depending on the type of fuel cell, the electrolyte 206 may take the form of a proton exchange membrane, a liquid solution of potassium hydroxide, a hard ceramic compound, a liquid salt, a phosphoric acid, and/or a combination thereof, among other examples.

The hydrogen supply 208 may refer to the source of hydrogen gas provided to the anode 202. As discussed above, with respect to a hydrogen fuel cell, hydrogen acts as the fuel that undergoes electrochemical reactions to produce electricity. This hydrogen may be stored as compressed gaseous hydrogen in the hydrogen supply 208. The hydrogen supply 208 may be implemented as a storage tank (e.g., a high pressure tank made of a material such as a carbon fiber-reinforced polymer), a reformer, and/or a combination thereof, among other examples.

The oxygen supply 210 may refer to the source of oxygen that is provided to the cathode 204. As discussed above, with respect to a hydrogen fuel cell, oxygen acts as the oxidizing agent. The oxygen may come from the ambient air, although sometimes pure oxygen, stored in an oxygen tank, may be used instead of or in addition to oxygen in the ambient air. When the oxygen supply 210 includes ambient air, the ambient air may be filtered, for example, to remove at least some nitrogen and possibly other gases.

The air compressor 212 may increase the pressure of the oxygen in the oxygen supply 210 (e.g., the ambient air) so the oxygen may be consistently delivered to the cathode 204. The increased pressure from the air compressor 212 may further help remove the water produced at the cathode 204, which can prevent flooding of the fuel cell 200 while regulating a temperature of the fuel cell 200 (e.g., removing heat from the fuel cell 200). The operation of the air compressor 212 (e.g., speed, pressure, etc., of the air) may be controlled by a compressor controller 218.

The humidifier 214 may humidify the hydrogen supply 208 and/or the oxygen supply 210 provided to the fuel cell 200. For example, the hydrogen supply 208 and the oxygen supply 210 fed to the fuel cell 200 may pass through the humidifier 214 before being provided to the anode 202 and the cathode 204, respectively. In some implementations, a portion of humidified exhaust gas might be recirculated back into the fuel cell 200 to maintain a humidity level.

Alternatively or in addition, the humidifier 214 may serve other purposes. For example, as discussed above, the electrolyte 206 may be in the form of a proton exchange membrane. If the proton exchange membrane dries out, the electrolyte 206 may not operate correctly. As the membrane dries out, the electrolyte 206 may lose its conductivity, which can reduce the overall efficiency of the fuel cell 200. Further, a dried membrane may crack, thereby resulting in a further decrease in efficiency. Humidifying the oxygen supply 210 may prevent the proton exchange membrane from drying out. Moreover, a humid environment can improve the reactions within the anode 202 and/or the cathode 204. For example, humidity may be used to create a gas diffusion layer between the electrolyte 206 and each of the anode 202 or the cathode 204. The gas diffusion layer may make it easier for the hydrogen, oxygen, and/or water byproduct to move throughout the different parts of the fuel cell 200. The humidifier 214 may also be used to control the moisture content of the hydrogen and/or oxygen, manage the temperature of the fuel cell 200 (e.g., by controlling evaporation), and/or a combination thereof, among other examples.

As discussed above, the byproduct of the fuel cell 200 is water. The water may be exhausted from the fuel cell 200, may be stored in a reservoir, may evaporate, may be recycled (e.g., electrolyzed to produce oxygen and/or hydrogen), and/or a combination thereof, among other examples.

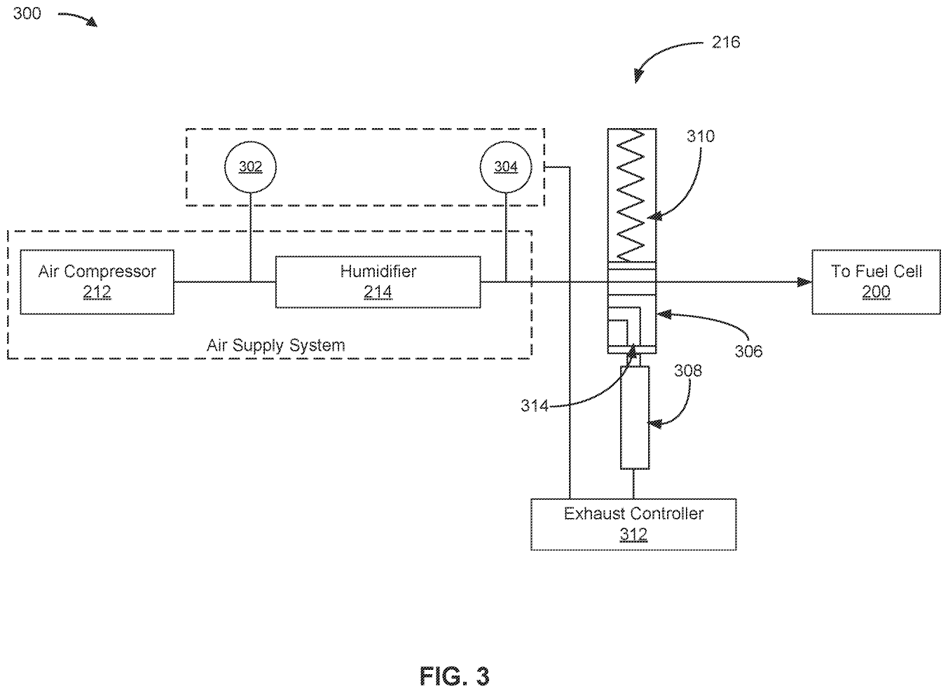

The dust purge system 216 may be used to detect and/or remove dust in the hydrogen supply 208, the oxygen supply 210, and/or a combination thereof, among other examples. For example, dust may be introduced by the hydrogen supply 208 and/or the oxygen supply 210. Dust in the fuel cell 200 can disrupt the oxidation and/or reduction reactions in the anode 202 and/or cathode 204, respectively. As discussed in greater detail below with respect to FIG. 3, the dust purge system 216 may detect dust in a fluid path between the humidifier 214 and the fuel cell 200 (e.g., the anode 202 and/or the cathode 204) and exhaust the dust into the ambient air.

As indicated above, FIG. 2 is provided as an example. Other examples are possible and may differ from what was described in connection with FIG. 2.

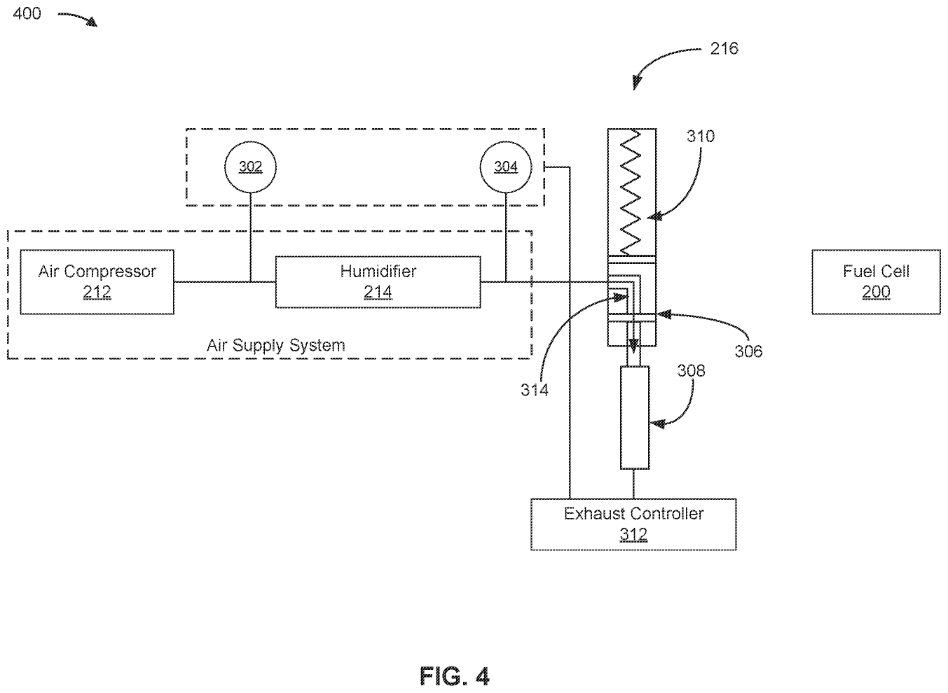

FIGS. 3 and 4 are diagrams of an examples 300 and 400, respectively, of the dust purge system 216 that may be used with the fuel cell 200. As discussed in greater detail below, the dust purge system 216 may incorporated into, and configured to selectively purge dust from, the air supply system of the fuel cell 200. As shown in FIG. 3, the dust purge system 216 includes an inlet pressure sensor 302, an outlet pressure sensor 304, a purge valve 306, an actuator 308, a biasing element 310, and an exhaust controller 312.

The inlet pressure sensor 302 may measure an inlet pressure of the humidifier 214. The inlet pressure of the humidifier 214 may be the pressure of a fluid path between the air compressor 212 and the humidifier 214. The inlet pressure sensor 302 may be configured to output a signal to the exhaust controller 312. The signal output by the inlet pressure sensor 302 may indicate or otherwise represent the inlet pressure of the humidifier 214 as measured by the inlet pressure sensor 302.

The outlet pressure sensor 304 may measure an outlet pressure of the humidifier 214. The outlet pressure of the humidifier 214 may be the pressure of a fluid path between the humidifier 214 and a component of the fuel cell 200 (such as, for example, the cathode 204). The outlet pressure sensor 304 may be configured to output a signal to the exhaust controller 312. The signal output by the outlet pressure sensor 304 may indicate or otherwise represent the outlet pressure of the humidifier 214 as measured by the outlet pressure sensor 304.

The purge valve 306 may be movable between an open position (see FIG. 3) and an exhaust position (see FIG. 4). When operating in the open position (see FIG. 3), the purge valve 306 may direct air output by the humidifier 214 to the fuel cell 200. When operating in the exhaust position (see FIG. 4), the purge valve 306 may vent air output by the humidifier 214 away from the fuel cell 200 (e.g., into the atmosphere). The purge valve 306 may include an exhaust port 314. When operating in the exhaust position (see FIG. 4), the exhaust port 314 is placed in the fluid path between the humidifier 214 and the fuel cell 200 (e.g., the cathode 204), thereby venting the air in the fluid path into the atmosphere and away from the fuel cell 200.

The actuator 308 may be a solenoid or another device configured to move the purge valve 306 to the exhaust position. The actuator 308 may be configured to move the purge valve 306 to the exhaust position in accordance with the inlet pressure, the outlet pressure, and/or a combination thereof, among other examples. For example, the actuator 308 may be configured to move the purge valve 306 to the exhaust position in accordance with a difference between the inlet pressure and the outlet pressure, as discussed in greater detail below. The actuator 308 may be configured to receive control signals output by the exhaust controller 312. For example, the actuator 308 may be configured to move the purge valve 306 to the exhaust position as a result of receiving a control signal from the exhaust controller 312. As discussed in greater detail below, moving the purge valve 306 to the exhaust position may include overcoming a force applied to the purge valve 306, via the biasing element 310, biasing the purge valve 306 in the open position.

The biasing element 310 may be operatively coupled to the purge valve 306 for biasing the purge valve 306 toward the open position. The biasing element 310 may include a spring or another device. The force of the biasing element 310 may be strong enough to keep the purge valve 306 in the open position when the actuator 308 is not attempting to move and/or keep the purge valve 306 in the exhaust position. The force of the biasing element 310 may be overcome, however, by a force of the actuator 308 on the purge valve 306.

The exhaust controller 312 may include a memory and a processor, and the exhaust controller 312 may be electrically connected to the inlet pressure sensor 302, the outlet pressure sensor 304, and the actuator 308. The exhaust controller 312 may be configured (e.g., programmed) to determine a difference between the inlet pressure and the outlet pressure and compare the difference between the inlet pressure and the outlet pressure to a first threshold. The first threshold may be a value that indicates that a sufficient amount of dust has accumulated in the humidifier 214 and has caused the outlet pressure of the humidifier 214 to significantly drop relative to the inlet pressure. As a result of determining that the difference between the inlet pressure and the outlet pressure exceeds the first threshold, the exhaust controller 312 may be configured to activate the actuator 308. For example, the exhaust controller 312 may be configured to output the control signal, discussed above, to the actuator 308, thereby causing the actuator 308 to move the purge valve 306 to the exhaust position. When the difference between the inlet pressure and the outlet pressure drops to a second threshold, which may be the same or lower than the first threshold or which may be zero (indicating no difference or a nominal difference between the inlet pressure and outlet pressure), the exhaust controller 312 may be configured to deactivate the actuator 308. A “nominal” difference may be a difference that is typical for a properly functioning humidifier 214 (e.g., a humidifier with little to no dust accumulation). The exhaust controller 312 may be configured to stop outputting the control signal to the actuator 308, which may allow the actuator 308 to retract and the biasing element 310 to push the purge valve 306 back to the open position, thereby permitting air from the humidifier 214 to reach the fuel cell 200. Alternatively, the exhaust controller 312 may be configured to deactivate the actuator 308 by outputting a different control signal that retracts the actuator 308 so the purge valve 306 can return to the open position (e.g., to direct air from the humidifier 214 to the fuel cell 200) with assistance from the biasing element 310. Alternatively, retracting the actuator 308 may allow the actuator 308 to pull the purge valve 306 to the open position without assistance from the biasing element 310.

Accordingly, when the difference between the inlet pressure and the outlet pressure exceeds the first threshold, which may indicate a significant amount of dust in the humidifier 214, the purge valve 306 may move to the exhaust position and vent air in the fluid path between the humidifier 214 and the fuel cell 200. Venting the air may expel dust that has accumulated in the humidifier 214 to an atmosphere, rather than directing the dust to the fuel cell 200.

As indicated above, FIGS. 3 and 4 are provided as examples. Other examples are possible and may differ from what was described in connection with FIGS. 3 and 4.

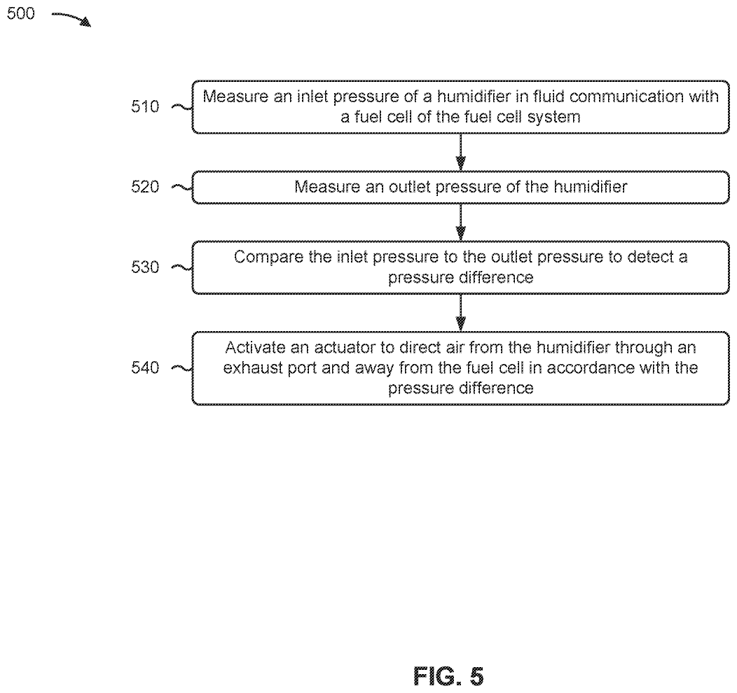

FIG. 5 is a flowchart of an example process 500 associated with detecting and removing dust from a fuel cell. One or more process blocks of FIG. 5 may be performed by a dust purge system (e.g., dust purge system 216). Additionally, or alternatively, one or more process blocks of FIG. 5 may be performed by another device or a group of devices separate from or including the dust purge system, such as another device or component that is internal or external to the machine and/or the air supply system, described above.

As shown in FIG. 5, process 500 may include measuring an inlet pressure of a humidifier 214 in fluid communication with a fuel cell of a fuel cell system (block 510). For example, the dust purge system may measure an inlet pressure of a humidifier 214 in fluid communication with a fuel cell of a fuel cell system, as described above.

As further shown in FIG. 5, process 500 may include measuring an outlet pressure of the humidifier (block 520). For example, the dust purge system may measure an outlet pressure of the humidifier, as described above.

As further shown in FIG. 5, process 500 may include comparing the inlet pressure to the outlet pressure to detect a pressure difference (block 530). For example, the dust purge system may compare the inlet pressure to the outlet pressure to detect a pressure difference, as described above.

As further shown in FIG. 5, process 500 may include activating an actuator 308 to direct air from the humidifier through an exhaust port and away from the fuel cell in accordance with the pressure difference (block 540). For example, the dust purge system may activate an actuator to direct air from the humidifier through an exhaust port and away from the fuel cell in accordance with the pressure difference, as described above.

The process 500 may include comparing the pressure difference to a threshold, and activating the actuator may occur as a result of the pressure difference being greater than the threshold. Activating the actuator to direct air from the humidifier through the exhaust port 314 may include actuating the actuator 308 to move the purge valve, including the exhaust port, to a position in a fluid path between the humidifier and the fuel cell. Alternatively or in addition, the process 500 may include retracting the actuator to direct air from the humidifier to the fuel cell, as discussed above with respect to FIGS. 3 and 4.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

### INDUSTRIAL APPLICABILITY

The dust purge system described herein may be used with any machine that is powered by fuel cells. For example, the dust purge system may be used in a work machine, which may operate in a dusty environment, such as a construction site or a mine. Using fuel cells in dusty environments increases the likelihood of dust interfering with the chemical processes involved in using hydrogen and oxygen to create electricity and power machinery. For example, dust can clog the air intake systems, inhibiting the supply of the oxygen that supports the chemical reactions facilitated in the fuel cells. Moreover, dust particles that infiltrate the fuel cell can cause damage and reduce the efficiency and lifespan of the fuel cell.

The dust purge system described herein allows for the detection and removal of dust before the dust can affect the fuel cell. As a result, the fuel cell may have a longer lifespan, and the machinery using the fuel cell may enjoy a longer uptime. Further, since fuel cells can be costly to maintain and replace, the dust purge system described above may reduce the costs associated with operating and maintaining machinery in dusty environments.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A dust purge system, comprising:
an inlet pressure sensor configured to measure an inlet pressure of a humidifier;
an outlet pressure sensor configured to measure an outlet pressure of the humidifier;
a purge valve movable between an open position to direct air output by the humidifier to a fuel cell and an exhaust position to vent air output by the humidifier away from the fuel cell; and
an actuator configured to move the purge valve to the exhaust position in accordance with a difference between the outlet pressure and the inlet pressure.

2. The dust purge system of claim 1, further comprising an exhaust controller electrically connected to the inlet pressure sensor, the outlet pressure sensor, and the actuator,
wherein the exhaust controller is configured to determine the difference between the outlet pressure and the inlet pressure.

3. The dust purge system of claim 2, wherein the exhaust controller is configured to compare the difference between the outlet pressure and the inlet pressure to a threshold.

4. The dust purge system of claim 2, wherein the exhaust controller is configured to output a control signal to the actuator as a result of the difference between the outlet pressure and the inlet pressure exceeding a threshold, and
wherein the actuator is configured to move the purge valve to the exhaust position in accordance with the control signal.

5. The dust purge system of claim 2, wherein the exhaust controller is configured to retract the actuator as a result of the difference between the outlet pressure and the inlet pressure being less than a threshold.

6. The dust purge system of claim 1, further comprising a biasing element operatively connected to the purge valve for biasing the purge valve toward the open position.

7. A fuel cell air supply system, comprising:
an air compressor;
a humidifier in fluid communication with the air compressor; and
a dust purge system in fluid communication with the humidifier,
the dust purge system being configured to selectively purge dust from the fuel cell air supply system, and
the dust purge system including:
an actuator; and
a purge valve, including an exhaust port, operatively connected to the actuator,
the purge valve being configured to move from an open position to direct air output by the humidifier to a fuel cell and an exhaust position to vent air output by the humidifier away from the fuel cell.

8. The fuel cell air supply system of claim 7, wherein the dust purge system includes a biasing element operatively connected to the purge valve for biasing the purge valve toward the open position.

9. The fuel cell air supply system of claim 7, wherein the actuator is configured to move the purge valve to the exhaust position.

10. The fuel cell air supply system of claim 7, further comprising:
an inlet pressure sensor in fluid communication with the air compressor and the humidifier and configured to measure an inlet pressure of the humidifier; and
an outlet pressure sensor in fluid communication with the humidifier and the dust purge system and configured to measure an outlet pressure of the humidifier.

11. The fuel cell air supply system of claim 10, wherein the actuator is configured to move the purge valve to the exhaust position in accordance with a difference between the inlet pressure and the outlet pressure.

12. The fuel cell air supply system of claim 10, wherein the dust purge system includes an exhaust controller electrically connected to the inlet pressure sensor, the outlet pressure sensor, and the actuator.

13. The fuel cell air supply system of claim 12, wherein the exhaust controller is configured to:
compare a difference between the inlet pressure and the outlet pressure to a threshold; and
activate the actuator as a result of the difference between the inlet pressure and the outlet pressure exceeding the threshold.

14. The fuel cell air supply system of claim 12, wherein the exhaust controller is configured to:
detect that the inlet pressure is greater than the outlet pressure; and
activate the actuator as a result of detecting that the inlet pressure is greater than the outlet pressure.

15. The fuel cell air supply system of claim 12, wherein the exhaust controller is configured to retract the actuator as a result of a difference between the inlet pressure and the outlet pressure being nominal.

16. A method of purging dust from an air supply system of a fuel cell system, the method comprising:
measuring an inlet pressure of a humidifier in fluid communication with a fuel cell of the fuel cell system;
measuring an outlet pressure of the humidifier;
comparing the inlet pressure to the outlet pressure to detect a pressure difference; and
activating an actuator to direct air from the humidifier through an exhaust port and away from the fuel cell in accordance with the pressure difference.

17. The method of claim 16, further comprising comparing the pressure difference to a threshold.

18. The method of claim 17, wherein activating the actuator occurs as a result of the pressure difference being greater than the threshold.

19. The method of claim 16, wherein activating the actuator to direct air from the humidifier through the exhaust port includes actuating the actuator to move a purge valve, including the exhaust port, to a position in a fluid path between the humidifier and the fuel cell.

20. The method of claim 16, further comprising retracting the actuator to direct air from the humidifier to the fuel cell.
